(19) United States
(12) Patent Application Publication
(10) Pub. No.: US 2026/0029672 A1
(43) Pub. Date: Jan. 29, 2026

(54) CO-PACKAGED OPTICS CHIP MODULE

(71) Applicant: Centera Photonics Inc., Hsinchu (TW)

(72) Inventors: Chin-Ta Chen, Hsinchu (TW); Kao-Feng Tsai, Hsinchu (TW)

(73) Assignee: Centera Photonics Inc., Hsinchu (TW)

(21) Appl. No.: 18/806,611

(22) Filed: Aug. 15, 2024

(30) Foreign Application Priority Data
Jul. 23, 2024 (TW) 113127500

(51) Int. Cl. G02F 1/065

(52) U.S. Cl. CPC G02F 1/065

(57) ABSTRACT

A co-packaged optics chip module includes a silicon substrate, a silicon-organic-hybrid modulator, a driving element, a photodetector, and an amplifier. The silicon-organic-hybrid modulator is disposed on the silicon substrate. The driving element is disposed on the silicon substrate and is electrically connected to the silicon-organic-hybrid modulator. The photodetector is disposed on the silicon substrate. The amplifier is disposed on the silicon substrate and is electrically connected to the photodetector. The silicon-organic-hybrid modulator and the photodetector are integrated on the silicon substrate.

### CROSS-REFERENCE TO RELATED APPLICATION

This application claims the priority benefit of Taiwan application serial no. 113127500, filed on Jul. 23, 2024. The entirety of the above-mentioned patent application is hereby incorporated by reference herein and made a part of this specification.

### BACKGROUND

### Technical Field

The disclosure relates to a chip module, and in particular to a co-packaged optics chip module.

### Description of Related Art

Among the commercial high-speed optical modulators currently on the market, mature optical modulators are mainly Mach-Zehnder modulators and micro-ring modulators. The Mach-Zehnder modulator requires a large input voltage and consumes more power, and the components of the Mach-Zehnder modulator are large and difficult to miniaturize. The component size of the micro-ring modulator is difficult to control, resulting in reduced photoelectric efficiency. In addition, the micro-ring modulators are highly sensitive to operating temperature, making it challenging for mass production.

### SUMMARY

The disclosure provides a co-packaged optics chip module, in which a light modulator thereof has small component size and wide operating temperature.

The co-packaged optics chip module of the disclosure includes a silicon substrate, a silicon-organic-hybrid modulator, a driving element, a photodetector, and an amplifier. The silicon-organic-hybrid modulator is disposed on the silicon substrate. The driving element is disposed on the silicon substrate and is electrically connected to the silicon-organic-hybrid modulator. The photodetector is disposed on the silicon substrate. The amplifier is disposed on the silicon substrate and is electrically connected to the photodetector. The silicon-organic-hybrid modulator and the photodetector are integrated on the silicon substrate.

In an embodiment of the disclosure, the silicon-organic-hybrid modulator includes a silicon photonic slot waveguide, an organic electro-optical material filling a slot of the silicon photonic slot waveguide, and an electrode connected to the silicon photonic slot waveguide; the photodetector includes a first-type semiconductor layer, a second-type semiconductor layer, a first electrode electrically connected to the first-type semiconductor layer, and a second electrode electrically connected to the second-type semiconductor layer; the electrode of the silicon-organic-hybrid modulator and at least one of the first electrode and the second electrode of the photodetector are formed on the same film layer.

In an embodiment of the disclosure, the co-packaged optics chip module further includes a first insulating layer disposed on the silicon substrate. The first insulating layer is located between the silicon photonic slot waveguide and the silicon substrate, and the first insulating layer is further located between the first-type semiconductor layer of the photodetector and the silicon substrate.

In an embodiment of the disclosure, the co-packaged optics chip module further includes a second insulating layer having a first opening and at least one second opening. The electrode of the silicon-organic-hybrid modulator is disposed on the second insulating layer and connected to the silicon photonic slot waveguide through the first opening of the second insulating layer. At least one of the first electrode and the second electrode of the photodetector is disposed on the second insulating layer and is electrically connected to at least one of the first-type semiconductor layer and the second-type semiconductor layer through the at least one second opening of the second insulating layer.

In an embodiment of the disclosure, the co-packaged optics chip module further includes an optical waveguide integrated on the silicon substrate and coupled to the silicon-organic-hybrid modulator.

In an embodiment of the disclosure, the co-packaged optics chip module further includes a pluggable substrate. An interposer substrate includes the silicon substrate, the silicon-organic-hybrid modulator, the driving element, the photodetector, and the amplifier. The interposer substrate is disposed on the pluggable substrate and is electrically connected to the pluggable substrate.

In an embodiment of the disclosure, the co-packaged optics chip module further includes a heat sink disposed on at least one of the driving element and the amplifier. The interposer substrate is located between the heat sink and the pluggable baseplate.

Based on the above, the co-packaged optics chip module of the disclosure includes a hybrid light modulator integrated on a silicon substrate. The silicon-organic-hybrid modulator integrated on the silicon substrate has low power consumption, small component size, and wide operating temperature. In addition, since the co-packaged optics chip module includes the silicon-organic-hybrid modulator and the photodetector integrated on the silicon substrate, the co-packaged optics chip module has both light emitting and light receiving functions.

### BRIEF DESCRIPTION OF THE DRAWINGS

FIG. 1 is a schematic cross-sectional view of an electronic system according to an embodiment of the disclosure.

FIG. 2 is a schematic three-dimensional view of an interposer substrate of a co-packaged optics chip module according to an embodiment of the disclosure.

FIG. 3 is a schematic cross-sectional view of a silicon-organic-hybrid modulator (SOH) of a silicon optical bench (SiOB) according to an embodiment of the disclosure.

FIG. 4 is a schematic cross-sectional view of a photodetector of a silicon optical bench (SiOB) according to an embodiment of the disclosure.

### DESCRIPTION OF THE EMBODIMENTS

Reference will now be made in detail to the exemplary embodiments. Examples of exemplary embodiments are described in the accompanying drawings. Wherever possible, the same reference symbols are used to denote the same or similar parts in the drawings and the description.

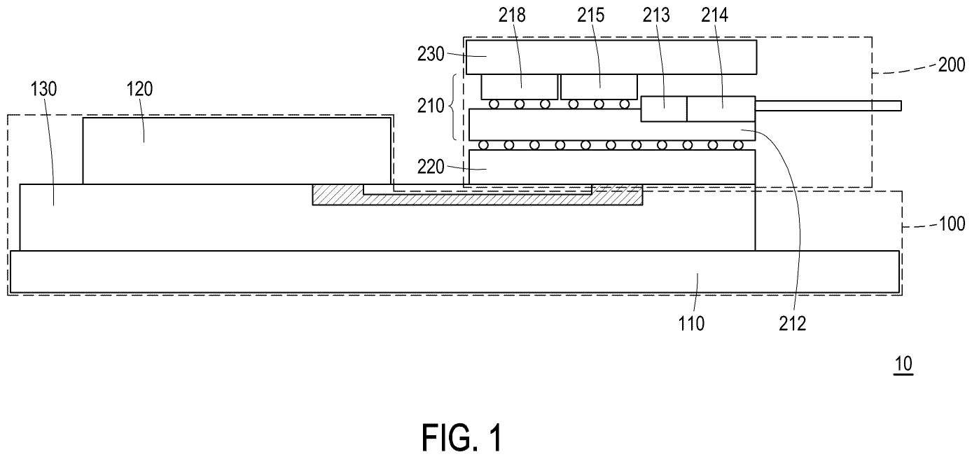

FIG. 1 is a schematic cross-sectional view of an electronic system according to an embodiment of the disclosure. Referring to FIG. 1, an electronic system 10 includes a system-in-package module 100 and a co-packaged optics (CPO) chip module 200. The co-packaged optics chip module 200 is suitable for being installed on the system-in-package module 100 and is electrically connected to the system-in-package module 100. In some embodiments, the co-packaged optics chip module 200 is pluggably installed on the system-in-package module 100, but the disclosure is not limited thereto.

In some embodiments, the system-in-package module 100 may optionally include a main circuit board 110 and an application specific integrated circuit (ASIC) chip 120. The ASIC chip 120 is disposed on the main circuit board 110 and is electrically connected to the main circuit board 110. In some embodiments, the system-in-package module 100 may also optionally include a carrier board 130. The carrier board 130 carries the ASIC chip 120 and is disposed on the main circuit board 110. The carrier board 130 is electrically connected to the ASIC chip 120 and the main circuit board 110.

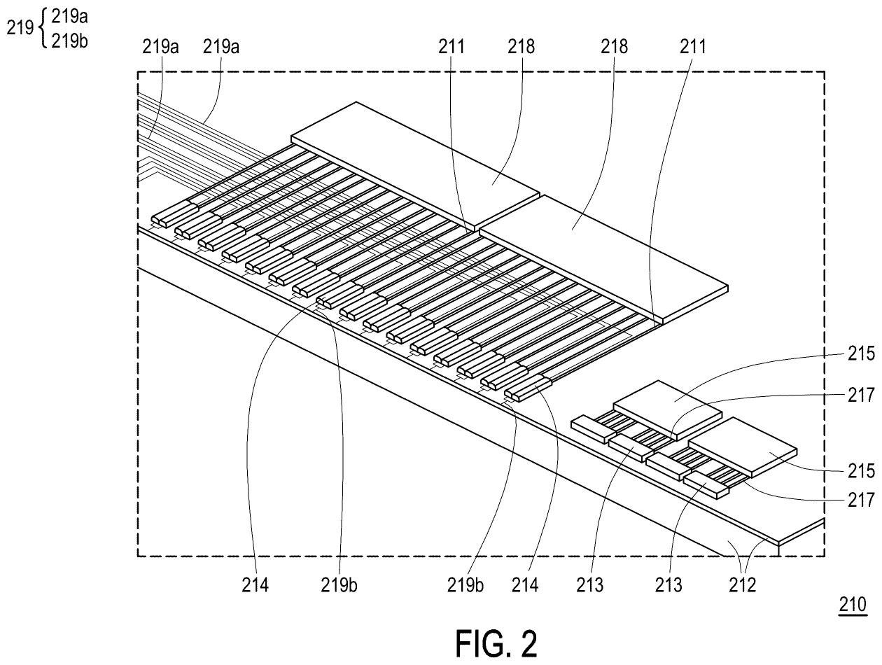

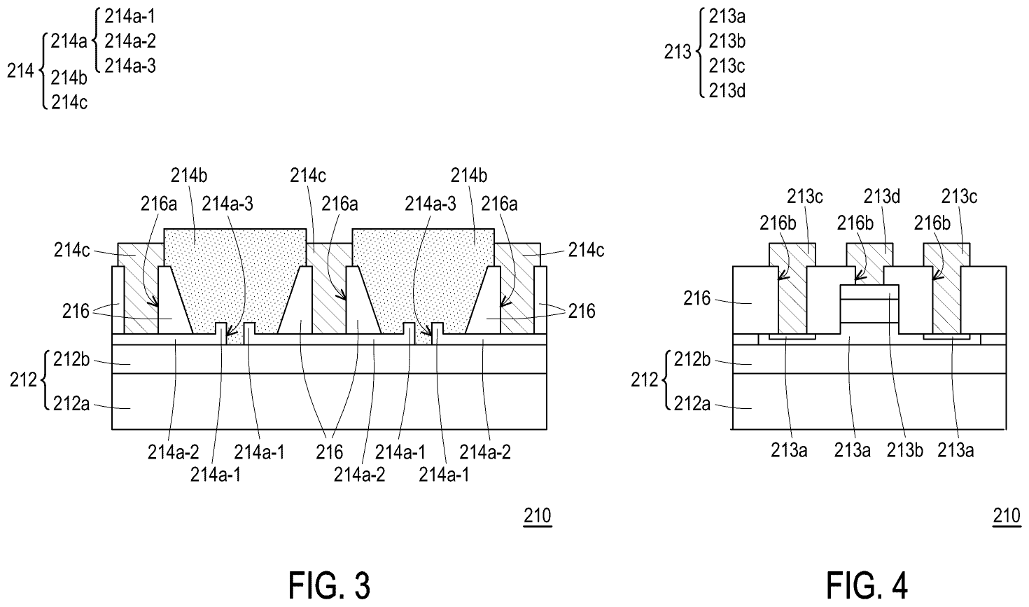

FIG. 2 is a schematic three-dimensional view of an interposer substrate of a co-packaged optics chip module according to an embodiment of the disclosure. FIG. 3 is a schematic cross-sectional view of a silicon-organic-hybrid modulator (SOH) of a silicon optical bench (SiOB) according to an embodiment of the disclosure. FIG. 4 is a schematic cross-sectional view of a photodetector of a silicon optical bench (SiOB) according to an embodiment of the disclosure.

Referring to FIGS. 1, 2, and 3, the co-packaged optics chip module 200 includes an interposer substrate 210. The interposer substrate 210 of the co-packaged optics chip module 200 includes a silicon optical bench 212. The silicon optical bench 212 includes a silicon substrate 212a. In some embodiments, the silicon optical bench 212 may further include a first insulating layer 212b. The first insulating layer 212b is disposed on the silicon substrate 212a. In some embodiments, a material of the first insulating layer 212b may be an inorganic material (such as silicon oxide, silicon nitride, silicon oxynitride, or a stacked layer of at least two of the above materials), an organic material, or a combination thereof.

Referring to FIGS. 1, 2, and 3, the interposer substrate 210 of the co-packaged optics chip module 200 further includes a silicon-organic-hybrid modulator (SOH) 214 disposed on the silicon substrate 212a. In particular, the silicon-organic-hybrid modulator 214 is integrated on the silicon substrate 212a. In some embodiments, a manufacturing process of the silicon-organic-hybrid modulator 214 may comply with a post-CMOS process, which is easy for mass production.

In some embodiments, the silicon-organic-hybrid modulator 214 may include a silicon photonic slot waveguide 214a, an organic EO material 214b filling a slot 214a-3 of the silicon photonic slot waveguide 214a, and an electrode 214c connected to the silicon photonic slot waveguide 214a. Specifically, in some embodiments, one silicon photonic slot waveguide 214a may include multiple erected portions 214a-1 and multiple extending portions 214a-2. The erected portions 214a-1 are disposed relatively and spaced apart from each other to define the slots 214a-3. The extending portions 214a-2 are respectively connected to the erected portions 214a-1 and extend in a direction away from the slots 214a-3.

In some embodiments, the interposer substrate 210 further includes a second insulating layer 216. The second insulating layer 216 is disposed on the extending portion 214a-2 of the silicon photonic slot waveguide 214a but not on the erected portion 214a-1 nor the slot 214a-3 of the silicon photonic slot waveguide 214a. In some embodiments, the second insulating layer 216 may have a first opening 216a, and the electrode 214c of the silicon-organic-hybrid modulator 214 is disposed on the second insulating layer 216 and is connected to the extending portion 214a-2 of the silicon photonic slot waveguide 214a through the first opening 216a of the second insulating layer 216. In some embodiments, the material of the second insulating layer 216 may be an inorganic material (such as silicon oxide, silicon nitride, silicon oxynitride, or a stacked layer of at least two of the above materials), an organic material, or a combination thereof.

Referring to FIGS. 1, 2, and 3, the interposer substrate 210 of the co-packaged optics chip module 200 further includes a driving element 218 for driving the silicon-organic-hybrid modulator 214. The driving element 218 is disposed on the silicon substrate 212a of the silicon optical bench 212 and is electrically connected to the silicon-organic-hybrid modulator 214. Specifically, in some embodiments, the interposer substrate 210 of the co-packaged optics chip module 200 further includes a first trace 211 disposed on the silicon optical bench 212. The silicon-organic-hybrid modulator 214 and the driving element 218 are electrically connected to each other through the first trace 211. In some embodiments, the first trace 211 is, for example, a high-speed trace, but the disclosure is not limited thereto.

Referring to FIGS. 2 and 3, in some embodiments, the silicon optical bench (SiOB) 212 further includes an optical waveguide 219. The optical waveguide 219 is integrated on the silicon substrate 212a of the silicon optical bench 212 and coupled to the silicon-organic-hybrid modulator 214. In some embodiments, the optical waveguide 219 may include a first optical waveguide 219a and a second optical waveguide 219b respectively disposed on different sides of the silicon-organic-hybrid modulator 214. The first optical waveguide 219a is used to receive a first light beam (not shown) emitted by an external light source (not shown) and transmit the first light beam to the silicon-organic-hybrid modulator 214. The first light beam is modulated by the silicon-organic-hybrid modulator 214 and is transmitted out through the second optical waveguide 219b carrying an optical signal.

Referring to FIGS. 1, 2, and 4, the interposer substrate 210 of the co-packaged optics chip module 200 further includes a photodetector 213 and an amplifier 215. The photodetector 213 and the amplifier 215 are disposed on the silicon substrate 212a of the silicon optical bench 212. The amplifier 215 is electrically connected to the photodetector 213. The photodetector 213 is used to receive a second light beam (not shown) carrying an optical signal, and convert the second light beam carrying an optical signal into a photocurrent carrying an electrical signal. The amplifier 215 amplifies the electrical signal carried by the photocurrent. Specifically, in some embodiments, the interposer substrate 210 of the co-packaged optics chip module 200 further includes a second trace 217 disposed on the silicon optical bench 212. In some embodiments, the second trace 217 is, for example, a high-speed trace, but the disclosure is not limited thereto.

Referring to FIGS. 2, 3, and 4, it is worth noting that the silicon-organic-hybrid modulator 214 used as a light emitting end and the photodetector 213 used as a light receiving end are integrated on the same silicon substrate 212a. In some embodiments, the photodetector 213 may be in a monolithic integration (SiGe PD) or a hybrid integration on the silicon optical bench 212.

Referring to FIGS. 2 and 4, the photodetector 213 includes a first-type semiconductor layer 213a, a second-type semiconductor layer 213b, a first electrode 213c electrically connected to the first-type semiconductor layer 213a, and a second electrode 213d electrically connected to the second-type semiconductor layer 213b. Referring to FIGS. 3 and 4, for example, in some embodiments, at least one of the electrode 214c of the silicon-organic-hybrid modulator 214 and the first electrode 213c or the second electrode 213d of the photodetector 213 may be formed on the same film layer.

Referring to FIGS. 3 and 4, in some embodiments, the first insulating layer 212b is located between the silicon photonic slot waveguide 214a and the silicon substrate 212a, and the first insulating layer 212b is further located between the first-type semiconductor layer 213a of the photodetector 213 and the silicon substrate 212a. In some embodiments, the second insulating layer 216 has at least one second opening 216b in addition to the first opening 216a overlapping the silicon photonic slot waveguide 214a. At least one of the first electrode 213c and the second electrode 213d of the photodetector 213 is disposed on the second insulating layer 216 and is electrically connected to at least one of the first-type semiconductor layer 213a and the second-type semiconductor layer 213b through the at least one second opening 216b of the second insulating layer 216.

Referring to FIG. 1, in some embodiments, the co-packaged optics chip module 200 may also optionally include a pluggable substrate 220. The interposer substrate 210 is disposed on the pluggable substrate 220 and is electrically connected to the pluggable substrate 220. Through the pluggable substrate 220, the co-packaged optics chip module 200 may be pluggably installed on the system-in-package module 100, and the interposer substrate 210 of the co-packaged optics chip module 200 may obtain power supply from the system-in-package module 100. In some embodiments, the pluggable substrate 220 may include fan-out circuits and land grid array (LGA) sockets, but the disclosure is not limited thereto.

Referring to FIG. 1, in some embodiments, the co-packaged optics chip module 200 may also optionally include a heat sink 230. The heat sink 230 is disposed on at least one of the driving element 218 and the amplifier 215. The interposer substrate 210 is located between the heat sink 230 and the pluggable substrate 220.

In summary, the co-packaged optics chip module according to an embodiment of the disclosure includes the silicon-organic-hybrid modulator and the photodetector integrated on the silicon substrate. The silicon-organic-hybrid modulator integrated on silicon substrates has low power consumption, small component size, and wide operating temperature. In addition, since the co-packaged optics chip module includes the silicon-organic-hybrid modulator and the photodetector integrated on the silicon substrate, the co-packaged optics chip module has both light emitting and light receiving functions.

What is claimed is:

1. A co-packaged optics chip module, comprising:
a silicon substrate;
a silicon-organic-hybrid modulator, disposed on the silicon substrate;
a driving element, disposed on the silicon substrate and electrically connected to the silicon-organic-hybrid modulator;
a photodetector, disposed on the silicon substrate; and
an amplifier, disposed on the silicon substrate and electrically connected to the photodetector;
wherein, the silicon-organic-hybrid modulator and the photodetector are integrated on the silicon substrate.

2. The co-packaged optics chip module according to claim 1, wherein the silicon-organic-hybrid modulator comprises a silicon photonic slot waveguide, an organic electro-optical material filled in a slot of the silicon photonic slot waveguide, and an electrode connected to the silicon photonic slot waveguide; the photodetector comprises a first-type semiconductor layer, a second-type semiconductor layer, a first electrode electrically connected to the first-type semiconductor layer, and a second electrode electrically connected to the second-type semiconductor layer; at least one of the electrode of the silicon-organic-hybrid modulator and the first electrode or the second electrode of the photodetector are formed on the same film layer.

3. The co-packaged optics chip module according to claim 2, further comprising:
a first insulating layer, disposed on the silicon substrate, wherein the first insulating layer is located between the silicon photonic slot waveguide and the silicon substrate, and the first insulating layer is further located between the first-type semiconductor layer of the photodetector and the silicon substrate.

4. The co-packaged optics chip module according to claim 2, further comprising:
a second insulating layer, having a first opening and at least a second opening, wherein the electrode of the silicon-organic-hybrid modulator is disposed on the second insulating layer and connected to the silicon photonic slot waveguide through the first opening of the second insulating layer, and at least one of the first electrode and the second electrode of the photodetector is disposed on the second insulating layer and is electrically connected to at least one of the first-type semiconductor layer and the second-type semiconductor through the at least one second opening of the second insulating layer.

5. The co-packaged optics chip module as according to claim 1, further comprising:
an optical waveguide, integrated on the silicon substrate and coupled to the silicon-organic-hybrid modulator.

6. The co-packaged optics chip module as according to claim 1, further comprising:
a pluggable substrate, wherein an interposer substrate comprises the silicon substrate, the silicon-organic-hybrid modulator, the driving element, the photodetector, and the amplifier, and the interposer substrate is disposed on the pluggable substrate and electrically connected to the pluggable substrate.

7. The co-packaged optics chip module according to claim 6, further comprising:
a heat sink, disposed on at least one of the driving element and the amplifier, wherein the interposer substrate is located between the heat sink and the pluggable substrate.
